(19) United States
(12) Patent Application Publication
(10) Pub. No.: US 2005/0124414 A1
(43) Pub. Date: Jun. 9, 2005

(54) Versatile audio/video signal delivery system

(76) Inventors: Saied Hussaini, Miami, FL (US); Marc Iacovelli, Miami, FL (US)

Correspondence Address: LINIAK, BERENATO & WHITE, LLC, 6550 ROCK SPRING DRIVE, SUITE 240, BETHESDA, MD, 20817, US

(21) Appl. No.: 10/835,262

(22) Filed: Apr. 30, 2004

Related U.S. Application Data
(60) Provisional application No. 60/527,775, filed on Dec. 9, 2003.

(51) Int. Cl. A63F 13/00

(52) U.S. Cl. 463/35

(57) ABSTRACT

An audio/video (A/V) signal delivery system is provided for transmitting an A/V signal from an audio/video output game port of one of a plurality of different video game consoles. The A/V delivery system comprises a central module including a plurality of A/V connectors and a corresponding plurality of A/V output module ports each connected to one of the plurality of A/V connectors, wherein each of the plurality of the A/V connectors is provided to mate with an A/V output game port of a corresponding one of a plurality of different video game consoles to transmit an audio signal and a video signal from one of the plurality of different video game consoles to corresponding one of the plurality of A/V output module ports of the central module. The central multi-port module also comprises associated output ports/pinout arrangements mirroring each of the aforementioned gaming platforms A/V output ports.

The present invention claims the benefit of provisional application 60/527,775 filed on Dec. 9, 2003 and is incorporated herein by reference.

### BACKGROUND OF THE INVENTION

1. Field of the Invention

The present invention relates to audio/video delivery systems in general, and more specifically to an audio/video signal delivery system adapted to facilitate use of a video display device and a set of wireless headphones with a plurality of audio/video devices, particularly a plurality of computer video gaming platforms.

2. Description of the Prior Art

Conventionally, computer video gaming platforms well known in the prior art, include one or more stereo headphone jacks to permit a hard-wired connection to sets of conventional headsets. Currently, non-portable video game systems do not have the ability to output audio and video on their own, and are dependent on the audio/video device to which they are connected. The vast majority of non-portable video game systems are connected to a television set, most of which do not have provisions for connecting earphones. If the users of the system are in a situation in which the audio creates a disruption for those around them, their options are either to completely turn off the system or mute the audio. Audio is an extremely important component in current video games, thus muting the audio greatly reduces the enjoyability of the game. Third-party accessories to connect earphones to a television or video game system have the severe drawback of being system-specific. To use earphones with another video game system (with a different gaming platform), the user must purchase another accessory specific to that system. Also, these products only facilitate connecting wired earphones to the video-game system or television, forcing the user to stay close to the device. This hindrance is compounded with the current popularity of wireless game controllers.

### SUMMARY OF THE INVENTION

The present invention provides a novel audio/video (A/V) signal delivery system provided for transmitting an A/V signal from an audio/video output game port of one of a plurality of different video game consoles.

The A/V delivery system in accordance with the present invention comprises a central module including a plurality of A/V connectors and a corresponding plurality of A/V output module ports each connected to one of the plurality of A/V connectors, wherein each of the plurality of the A/V connectors is provided to mate with an A/V output game port of a corresponding one of a plurality of different video game consoles to transmit an audio signal and a video signal from one of the plurality of different video game consoles to corresponding one of the plurality of A/V output module ports of the central module. The central multi-port module also comprises associated output ports/pinout arrangements mirroring each of the aforementioned gaming platforms A/V output ports.

The A/V signal delivery system of the present invention further includes at least one set of wireless headphones having a wireless receiver, and the central module further includes a wireless transmitter unit provided to transmit the audio signal to the wireless receiver of the at least one set of wireless headphones.

Such an arrangement facilitates use of the gaming platforms A/V connections provided with their system. Thus no additional A/V cables are required to employ the present invention with the use of one of a plurality of gaming platforms to a plurality of audio delivery devices.

### BRIEF DESCRIPTION OF THE DRAWINGS

Other objects and advantages of the invention will become apparent from a study of the following specification when viewed in light of the accompanying drawings, wherein:

FIG. 1 is a schematic view of a wireless audio delivery system in accordance with a preferred embodiment of the present invention;

FIG. 2 is a schematic view of an electric circuit of a central multi-port module a a set of headphones of the wireless audio delivery system in accordance with the preferred embodiment of the present invention.

### DETAILED DESCRIPTION OF PREFERRED EMBODIMENTS

The preferred embodiment of the present invention will now be described with the reference to accompanying drawings.

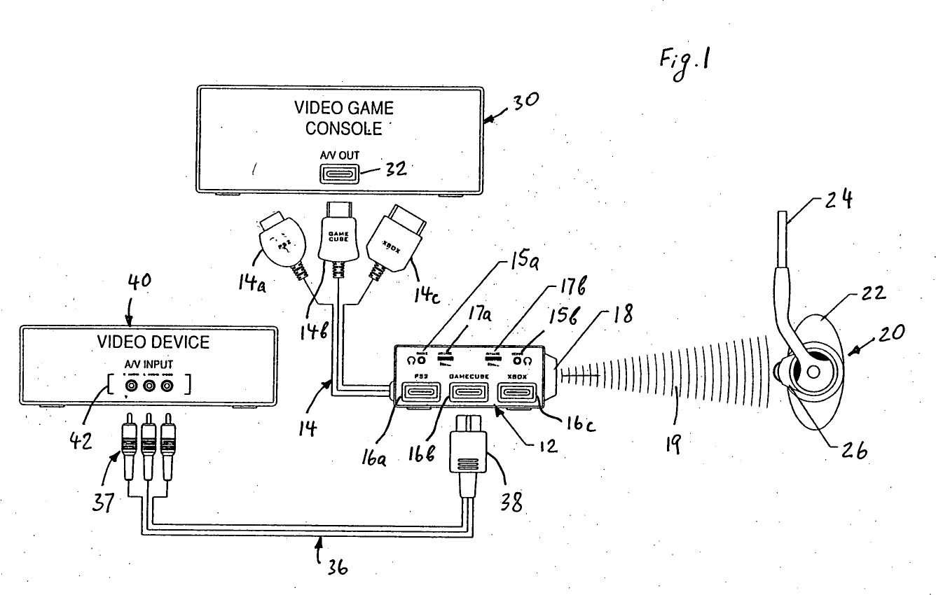

FIG. 1 depict a versatile wireless audio delivery system in accordance with a preferred embodiment of the present invention, generally labeled with the reference numeral 10. The wireless audio delivery system 8 comprises a central multi-port module 12, at least one set of wireless headphones 20, a video game console 30 and a video display device 40.

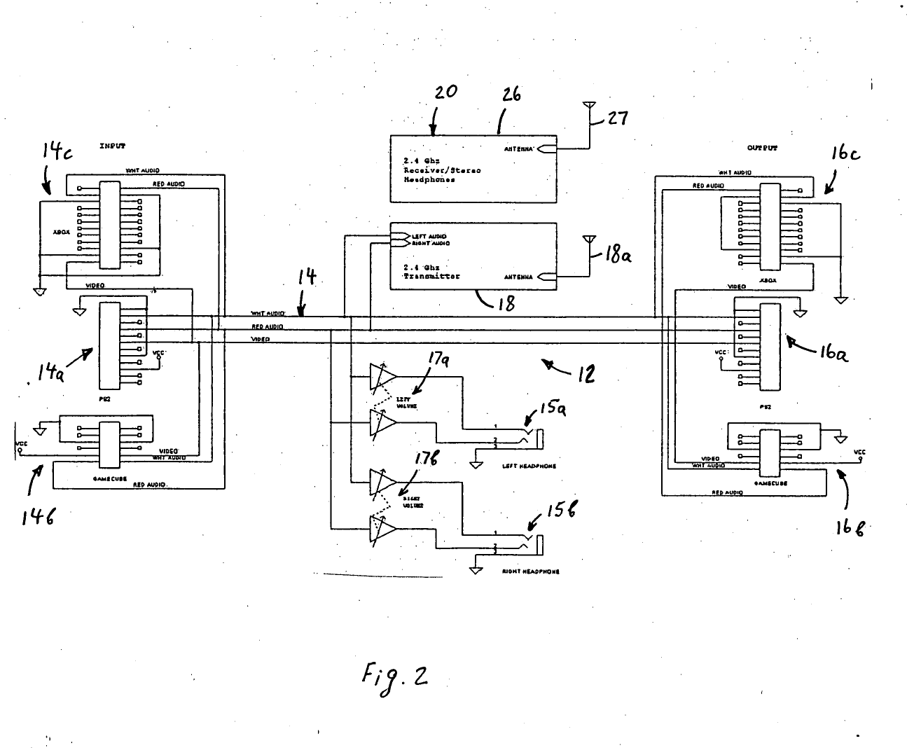

The central multi-port module 12 includes an audio/video (A/V) cable 14 provided with a plurality of audio/video (A/V) connectors, such as plugs, at a distal end thereof specifically adapted to mate with a variety of audio/video (A/V) signal sources such as the video game console 30 of different gaming platforms. Preferably, the central multi-port module 12 has three A/V plugs 14a, 14b and 14c each specifically adapted to mate with the video game console 30 of one of three different gaming platforms. More specifically, the A/V plug 14a is adapted to mate with the Sony's Playstation II unit, the A/V plug 14b is adapted to mate with the Nintendo's Game Cube, and the A/V plug 14c is adapted to mate with the Microsoft's X-box. Each of these video game consoles 30 have particular connections/pinouts associated with their audio/video (A/V) output port 32. Therefore, each of these A/V plugs 14a, 14b and 14c has particular connections/pinouts corresponding to the particular gaming platform of the video game console (the Sony's Playstation II unit, Nintendo's Game Cube and Microsoft's X-box, respectively) it is adapted to be connected to. Moreover, each of these A/V plugs 14a, 14b and 14c is connected to an audio/video input circuitry of the central multi-port module 12, shown in FIG. 2, to transmit an audio signal and a video signal from the video game console 30 to the central multi-port module 12 through the A/V cable 14. It will be appreciated by those skilled in the art that the audio signal transmitted from the video game console 30 to the central multi-port module 12 includes left and right stereo audio signals.

The central multi-port module 12 further includes a plurality of audio/video (A/V) output ports each adapted to be connected with the corresponding A/V output port 32 of the video game console 30 which may be of different gaming platforms, such as the Sony's Playstation II unit, Nintendo's Game Cube and Microsoft's X-box, etc. Preferably, the central multi-port module 12 has three A/V output ports 16a, 16b and 16c each connected to the A/V plugs 14a, 14b and 14c, respectively. Thus, the A/V output port 16a provides the output port for the Sony's Playstation II unit, the A/V output port 16b provides the output port for the Nintendo's Game Cube, and the A/V output port 16c provides the output port for the Microsoft's X-box. The A/V output ports 16a, 16b and 16c have pinout arrangements mirroring pinout arrangements of the A/V output port of the video game console of the associated one of the aforementioned gaming platforms. Thus, the A/V output port 16a mirrors the A/V output port/pinout arrangement of the Sony's Playstation II unit, the A/V output port 16b mirrors the A/V output port/pinout arrangement of the Nintendo's Game Cube, and the A/V output port 16a mirrors the A/V output port/pinout arrangement of the Microsoft's X-box.

The central module 12 is adapted to be connected to the video display device 40, such as a TV or other video display, by a video pass-through device in the form of an audio/video (A/V) cable 36 to facilitate delivery of the video signal to the video display device 40. As illustrated in FIG. 1, the A/V cable 36 having a conventional A/V connectors 37 at one end, and an A/V plug 38 at the other end thereof. The A/V connectors 37 are adapted to mate with an A/V input 42 of the video display device 40, while the A/V plug 38 is adapted to mate with one of the plurality of the A/V output ports 16a, 16b and 16c of the central multi-port module 12. It is to be understood that the A/V cable 36 should be specific to the particular gaming platform used. The game platform specific A/V cable conventionally comes with each video game console.

Furthermore, the central multi-port module 12 includes a wireless radio frequency (RF) transmitter unit 18 provided with a transmitting antenna 18a, as illustrated in FIG. 2. Each of the left and right stereo audio signals is routed to the wireless RF transmitter 18 for local broadcast of an audio output signal 19 to the set of wireless headphones 20 through the transmitting antenna 18a. Preferably, the transmission is broadcast at 2.4 GHz as will be appreciated and understood within the art. It is also to be understood that any conventional RF transmitting units may be employed in the central module 12 of the present invention.

The set of headphones 20 includes a pair of earphones 22 and an adjustable head support 24 adapted to support the earphones 22 on a head of a user (not shown). The set of headphones 20 is further equipped with a receiver unit 26 including a receiver antenna 27 a battery pack to facilitate reception of the broadcast of the audio output signals 19 to headphone speakers disposed in the earphones 22 and positioned to be located adjacent an ear of the user. It is understood that the broad concept of transmitting audio signals to a wireless head set is within the prior art for conventional stereo receiver units, etc., such as those disclosed by U.S. Pat. Nos. 6,522,368 6,006,115 and 4,845,751 each of which are hereby incorporated herein by reference.

This allows the single A/V output port 32 of the video game console 30 to be employed with the set of wireless headphones 20, and deliver the A/V signals directly to the video display device 40. Such an arrangement allows for selective use of either the audio equipment of the video display device or the wireless headphones (see attached drawing FIGS. 1 and 2 that shows stereo audio signals delivered to the video display device 40 in conjunction with the video signal). The central module 12 also includes a pair of stereo headphone jacks 15a and 15b to permit a hard-wired connection to a plurality of sets of conventional headsets. Independent volume control 17a and 17b is provided for each of the separate headphone jacks 15a and 15b.

Therefore, the present invention has several advantages over the prior art. The audio/video signal delivery system of the present invention facilitates a single installation of A/V cable connection while permitting selective delivery of audio signals via one of: 1) wireless headphones; 2) the audio components of the video display device; or 3) each of a plurality of separately controlled hard wired conventional headsets.

The foregoing description of the preferred embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. An audio/video signal delivery system comprising:
a central module including a plurality of audio/video connectors and a corresponding plurality of audio/video output ports each connected to one of said plurality of audio/video connectors thereby establishing a pass through connection therebetween;
each of said plurality of audio/video connectors is provided to mate with an audio/video output port of a corresponding one of a plurality of different audio/video devices to transmit an audio signal and a video signal from one of said plurality of different audio/video devices to corresponding one of said plurality of audio/video output module ports of said central module;
said central module further including a wireless transmitter unit provided to transmit said audio signal to at least one set of wireless headphones having a wireless receiver.

2. The audio/video signal delivery system as defined in claim 1, wherein each said of audio/video output ports of said central module is adapted to mate with said corresponding one of said plurality of audio/video connectors.

3. The audio/video signal delivery system as defined in claim 1, wherein each said of audio/video output ports of said central module is identical to said audio/video output game port of said corresponding one of said plurality of different audio/video devices.

4. The audio/video signal delivery system as defined in claim 1, wherein said plurality of audio/video connections of said central multi-port module is a plurality of audio/video plugs each adapted to engage said audio/video output port of said corresponding one of said plurality of different audio/video devices.

5. The audio/video signal delivery system as defined in claim 4, wherein said plurality of audio/video connectors of said central module includes first, second and third audio/video plugs having different plug configuration; each of said first, second and third audio/video plugs configured to mate with one of said plurality of different audio/video devices.

6. The audio/video signal delivery system as defined in claim 5, wherein said plurality of audio/video output ports of said central module further includes a first, second and third audio/video output ports each identical to said audio/video output game port of corresponding one of said plurality of different audio/video devices.

7. The audio/video signal delivery system as defined in claim 1, wherein said wireless transmitter unit is a radio frequency transmitter.

8. The audio/video signal delivery system as defined in claim 1, wherein said wireless transmitter unit of said central multi-port module transmits said audio/video signal at a frequency of at least 2.4 GHz.

9. The audio/video signal delivery system as defined in claim 1, wherein said central module includes at least one stereo headphone jack provided to permit a hard-wired connection to a of sets of headsets.

10. The audio/video signal delivery system as defined in claim 9, wherein said central module further includes at least one volume control unit associated with said at least one stereo headphone jack.

11. The audio/video signal delivery system as defined in claim 1, wherein each of said plurality of audio/video output ports of said central module is adapted to be connected to a video display device thereby establishing a pass through connection therebetween to transmit said audio signal and said video signal between one of said plurality of different audio/video devices and said video display device.

12. An audio/video signal delivery system comprising:
a central module including at least one audio/video connector and at least one corresponding audio/video output port connected to said at least one audio/video connector thereby establishing a pass through connection therebetween;
said at least one audio/video connector is provided to mate with an audio/video output port of a corresponding electronic video game console to transmit an audio signal and a video signal from said electronic video game console to said at least one audio/video output ports of said central module;
said central module further including a wireless transmitter unit provided to transmit said audio signal to at least one set of wireless headphones having a wireless receiver.

13. The audio/video signal delivery system as defined in claim 12, wherein said at least one audio/video output port of said central module is adapted to be connected to a video display device thereby establishing a pass through connection therebetween to transmit said audio signal and said video signal between said electronic video game console and said video display device.

14. The audio/video signal delivery system as defined in claim 12, wherein said central module includes at least one stereo headphone jack provided to permit a hard-wired connection to a of sets of headsets.

15. The audio/video signal delivery system as defined in claim 14, wherein said central module further includes at least cne volume control unit associated with said at least one stereo headphone jack.

16. The audio/video signal delivery system as defined in claim 12, wherein said wireless transmitter unit is a radio frequency transmitter.

17. The audio/video signal delivery system as defined in claim 12, wherein said wireless transmitter unit of said central multi-port module transmits said audio/video signal at a frequency of at least 2.4 GHz.
